(19) United States
(12) Patent Application Publication
(10) Pub. No.: US 2025/0204725 A1
(43) Pub. Date: Jun. 26, 2025

(54) COFFEE OR SPICE GRINDER

(71) Applicant: Eduard BIERNATEK, Rodgau (DE)

(72) Inventor: Eduard BIERNATEK, Rodgau (DE)

(21) Appl. No.: 18/961,771

(22) Filed: Nov. 27, 2024

(30) Foreign Application Priority Data
Nov. 28, 2023 (LU) LU505640

(51) Int. Cl. A47J 42/50; A47J 42/04; A47J 42/08

(52) U.S. Cl. CPC A47J 42/50; A47J 42/04; A47J 42/08

(57) ABSTRACT

The invention relates to a coffee or spice mill having a housing which has an opening, and having a closure device which is disposed in the region of the opening and by means of which a receptacle reservoir for the material to be ground, disposed in the housing, is able to be closed. The coffee or spice mill is characterized in that the closure device has two closure components of which at least one is mounted so as to be movable relative to the housing, and which are able to be transferred relative to one another selectively to an open position, in which material to be ground is able to be filled into the receptacle reservoir, or a closed position, in which no material to be ground is able to be filled into the receptacle reservoir.

### CROSS-REFERENCE TO RELATED APPLICATIONS

The present application claims priority to and benefit of Luxembourgian Patent Application No. 505640 filed Nov. 27, 2023, the entire disclosure of which is incorporated herein by reference.

### FIELD

The disclosure relates to a coffee or spice mill having a housing, which has an opening, and having a closure device which is disposed in the region of the opening and by means of which a receptacle reservoir for the material to be ground, disposed in the housing, is able to be closed.

### BACKGROUND

Known from patent application US 2018 0279829 A1 is a coffee mill which has a grinding unit having a grinding cone and a drive shaft, the one end of the latter being coupled to the grinding cone so as to interact with it. Formed on the other end is a rectangular shaft portion to which an activation handle, which has a rectangular clearance for the end of the shaft, is attached. The coffee mill contains a disk-shaped cover which is removably attached to the upper end opening of a container main body. Moreover, the coffee mill contains a cylindrical storage container for the ground material, which is removably attached to a lower end opening of the container main body and is open towards the top.

### SUMMARY

It is an object of the present disclosure to specify a coffee or spice mill of the type mentioned at the outset, which enables easy filling of the material to be ground, and in which the material to be ground can be stored in a protected manner until a grinding procedure takes place.

The object is achieved by a coffee or spice mill which is characterized in that the closure device has two closure components of which at least one is mounted so as to be movable relative to the housing, and which are able to be transferred relative to one another selectively to an open position, in which material to be ground is able to be filled into the receptacle reservoir, or a closed position, in which no material to be ground is able to be filled into the receptacle reservoir.

The disclosure has the very particular advantage that the housing can be opened for a filling procedure and subsequently closed again in a simple manner, without components having to be temporarily removed from the coffee or spice mill for this purpose. It is advantageously guaranteed in this way that no components can be inadvertently lost. In particular, the coffee or spice mill can nevertheless be advantageously designed in such a manner that it can be completely or at least partially disassembled, in particular without tools, for a cleaning procedure.

Moreover, the disclosure has the advantage that filling of material to be ground is made possible without having to disassemble a cover, for which purpose the crank handle also has to be additionally temporarily disassembled in the coffee mill known from the above-mentioned patent application US 2018 0279 829 A1.

In one advantageous embodiment, at least one of the closure components has at least one passage opening, which in the closed position is covered by the other one of the closure components and in the open position is not covered by the other one of the closure components. When the closure components are slightly spaced apart from one another (preferably by less than 2 mm, in particular less than 1 mm), a closure which suffices for the storage of coffee beans or spices, such as, for example peppercorns or salt granules, is nevertheless achieved. However, it is also possible that the closure components rest directly on one another, at least in the closed position, so that a very tight closure can be achieved in the closed position.

For example, it can be advantageously provided that both closure components each have at least one passage opening, wherein the at least one passage opening of the one closure component in the open position is co-aligned with the at least one passage opening of the other closure component.

Alternatively or additionally, it can also be provided that at least one of the closure components has a plurality of passage openings, in particular exactly two or exactly three passage openings, which in the closed position are covered by the other one of the closure components, and in the open position are not covered by the other one of the closure components. In particular, both closure components can each have a plurality of passage openings, in particular in each case exactly two or exactly three passage openings, for example, wherein the passage openings of the one closure component in the open position are co-aligned with the passage openings of the other closure component. In such an embodiment, both closure components preferably have the same number of passage openings.

Alternatively however, it is also possible that one of the closure components has no passage openings but is designed and disposed in such a way that it does not fill the entire area of the opening, so that at least one passage, which in the closed position is covered and in the open position is not covered by the other closure component, remains between the closure component and the housing.

The at least one passage opening can be formed in a circular disk-shaped or funnel-type portion of the closure component. Alternatively or additionally, both closure components can each have a circular disk-shaped or funnel—type portion, wherein at least one passage opening is in each case formed in each of the circular disk-shaped or funnel-type portions. The funnel-type portion can be designed, for example, as an annular funnel which has an annular channel, wherein at least one passage opening can be formed on the base of the channel. In one embodiment in which both closure components each have a circular disk-shaped or funnel-type portion, the circular disk-shaped or funnel-type portions are preferably of identical design and disposed so as to be parallel to one another (preferably resting directly on one another or being at a minor spacing of less than 2 mm, in particular less than 1 mm).

In one advantageous embodiment, the at least one passage opening is disposed so as to be spaced apart from the central axis of the circular disk-shaped or funnel-type portion. In such an embodiment, the closure component can have a cutout for a drive shaft or receptacle for a bearing, in particular a rolling bearing, for rotatably mounting a drive shaft, in the region of the central axis.

Very generally, it can advantageously be provided that one of the closure components is mounted so as to be movable relative to the other closure component. In particular, one of the closure component can be mounted so as to be rotatable relative to the other closure component.

In one very particularly advantageous embodiment, the rotatable mounting is implemented by means of a threaded connection. Such an embodiment has the very particular advantage that the closure component rotatably mounted in this way is indeed rotatable, but cannot be inadvertently released when switching between the closed position and the open position, or between the open position and the closed position (for which only a fraction of a full rotation is required), when the closure component has been screwed in by performing a plurality of revolutions.

In such an embodiment, in which the rotatable mounting is implemented by means of a threaded connection, the axial displacement which the closure component performs when switching between the closed position and the open position, or between the open position and the closed position, is not relevant to the function of the closure device, because only a fraction of a full revolution is required for the switching procedure, so that the displacement is minor. In particular, the thread and the mating thread (for example as a fine thread) can have a minor pitch so that the axial displacement is particularly minor.

In particular, it can advantageously be provided that the rotatably mounted closure component has a thread which is screwed into a mating thread that is stationary relative to the other closure component and/or the housing. In one embodiment which can be designed to be particularly robust and relies on just a few components, the rotatably mounted closure component has a thread, in particular an external thread, which is screwed into a mating thread which is formed on the housing and can in particular be designed as an internal thread. For example, the mating thread formed on the housing can be formed on one end of the, in particular tubular, wall of the housing. It is also possible that the thread is designed as an internal thread, while the mating thread is designed as an external thread.

In one very particularly advantageous embodiment, there is a tensioning element which radially and/or axially braces the thread directly or indirectly relative to the mating thread. Rattling is avoided in this way. Moreover, unintentional switching from the closed position to the open position, or from the open position to the closed position, is avoided because the tensioning element causes friction between the thread and the mating thread, which friction has to be overcome for a switching procedure. The tensioning element can be designed, for example, as a spring or as an elastomer component, in particular as a rubber ring, for example an O-ring. In particular, a groove in which the tensioning element designed as an O-ring is disposed, can be formed in the thread and/or in the mating thread.

In one very particularly advantageous embodiment, which relies on just a few components, at least one of the closure components (in addition to its function as a constituent part of the closure device) functions as a bearing bracket for rotationally mounting a drive shaft of the grinding gear that is rotatable relative to the housing. In particular, at least one of the closure components can have a rolling bearing, in particular a ball bearing or a needle bearing, or a plain bearing. Additionally (separately of the closure device), there can be at least one additional bearing bracket, in particular having a rolling bearing or a plain bearing, by means of which the drive shaft is rotatably mounted. The drive shaft is preferably supported by two bearings.

In one particularly compact and ergonomically designable embodiment, a drive shaft extends through at least one of the closure components. It can in particular be advantageously provided that the drive shaft extends through both closure components. At the end side, the drive shaft can be co-rotationally connected to a grinding cone of a grinding gear, which is disposed in a grinding ring of the grinding gear. The other end can be co-rotationally connected to a handle, for example a crank.

The drive shaft can in particular be disposed co-axially with the central axis of the circular disk-shaped or funnel-type portion.

Very generally, the drive shaft can advantageously extend along the central longitudinal axis of the housing.

In one very particularly advantageous embodiment, one of the closure components has a funnel-shaped portion in order to function as a funnel for filling material to be ground. The funnel-shaped portion can advantageously protrude radially outwards beyond the housing, which facilitates the filling procedure. The funnel-shaped portion (for example as an injection-molded part) can be formed integrally, conjointly with the circular disk-shaped or funnel-type portion that has at least one passage opening.

In one particular embodiment, one of the closure components is disposed so as to be immovable relative to the housing. In this embodiment, the other one of the closure components can be mounted so as to be movable, in particular rotatable, relative to the housing.

The closure component that is disposed so as to be immovable relative to the housing can be fastened, in particular directly, to the housing. It can in particular be advantageously provided that the closure component that is disposed so as to be immovable relative to the housing is fastened, in particular directly, in a friction- fitting manner, in particular exclusively in a friction-fitting manner, to the housing, in particular to the inside of a housing wall. For example, the closure component that is disposed so as to be immovable relative to the housing, on its outer circumferential periphery can have an elastic element, in particular an elastomer component, for example an elastomer ring, which may be a rubber ring and/or an O-ring, which rests on the inside of the housing. Alternatively or additionally, the closure component that is disposed so as to be immovable relative to the housing can have a circular disk-shaped or funnel-type portion having a groove which is formed on the outer circumferential periphery and into which is inserted an elastomer ring, in particular a rubber ring, for example an O-ring.

Very generally, it can advantageously be provided that the closure component that is disposed so as to be immovable relative to the housing is fastened to the housing in a form-fitting manner. Alternatively or additionally, it is also possible that the closure component that is disposed so as to be immovable relative to the housing is fastened, in particular directly, to the housing in a materially integral manner. Such an embodiment is particularly robust. However, such an embodiment has the disadvantage that it cannot be completely disassembled for a cleaning procedure. The closure component that is disposed so as to be immovable relative to the housing is preferably fastened, in particular directly, to the inside of the housing without a materially integral connection.

In one very particularly advantageous embodiment, the closure component that is disposed so as to be immovable relative to the housing is designed in the shape of a rod. An embodiment in which the ends of the closure component which is immovably disposed are shaped so as to be complementary to those portions of the housing on which said ends rest is particularly precise. For example, the closure component can have a rod which in terms of its direction of longitudinal extent is disposed perpendicularly to the direction of longitudinal extent of the, in particular tubular, housing, and is clamped in the interior of the housing. It can advantageously be provided here that each of the ends of the rod-shaped closure component has a contact portion which is shaped so as to be complementary to the portion of the housing on which said contact portion rests. However, other embodiments in which a closure component is designed as a rod are also possible.

In one particular embodiment, the closure component that is disposed so as to be immovable relative to the housing and is preferably of a rod-shaped design has a circular segment-shaped cross section. Such a closure component can advantageously be inserted into a tubular housing, in particular in a form-fitting and/or friction-fitting manner. In particular, such a closure component can have a flat area that is aligned with the other closure component.

In one very particularly advantageous embodiment, one of the closure components is disposed so as to be immovable relative to a drive shaft which is operatively coupled to the grinding gear. The other one of the closure components here can be mounted so as to be movable, in particular rotatable, relative to the housing. It can in particular be advantageously provided that the closure component that is disposed so as to be immovable relative to the drive shaft is fastened, in particular directly, to the drive shaft. The closure component that is disposed so as to be immovable relative to the drive shaft is preferably fastened to the drive shaft so as to be releasable in a non-destructive manner and/or without tools.

The closure component that is disposed so as to be immovable relative to the drive shaft can advantageously be designed as a funnel, and to this extent be multifunctional.

The closure component that is disposed so as to be immovable relative to the drive shaft can alternatively or additionally be designed as an activation handle by means of which the grinding gear is able to be driven, and to this extent also be multifunctional.

According to an independent concept of the disclosure, which can be implemented individually or in combination with at least one of the other features described herein, the coffee or spice mill has an activation handle, which is designed as a funnel for filling material to be ground, for driving a grinding gear.

In one particular embodiment which relies on just a few components, the closure component that is disposed so as to be immovable relative to the drive shaft is mounted by means of a rolling bearing so as to be rotatable relative to the housing.

The coffee or spice mill can have an activation handle. In particular when the mill is designed as a coffee mill, the activation handle can advantageously be designed as a crank handle. In particular when the mill is designed as a spice mill, the activation handle can advantageously be designed as a rod handle, to which the drive shaft is attached centrically, or be designed as a ball.

In an embodiment which is able to be designed in a compact manner, the closure device is disposed between the activation handle and the receptacle reservoir.

In one advantageous embodiment which is in particular particularly robust and able to be designed in a precise manner, the housing is of a tubular design, wherein the opening is formed by one of the tubular openings, in particular an upper tubular opening. The housing preferably has a dispensing opening for the coffee powder, or the ground spices. The dispensing opening can be formed by a lower tubular opening.

The housing in a cross-sectional plane perpendicular to the direction of longitudinal extent of said housing can have a circular external contour and/or circular internal contour. Such an embodiment can in particular be designed as an ergonomic hand-held mill.

The housing can advantageously be manufactured integrally from a single piece of raw material, in particular from a tube. Such an embodiment can be designed in a particularly robust and ergonomic manner, and moreover in a very precise manner, in particular because a tube can be manufactured particularly precisely, for example by a turning procedure.

In one advantageous embodiment, at least one of the closure components is able to be assembled in or on the housing without tools, and/or releasable from the housing without tools. Such an embodiment can easily be at least partially disassembled for a cleaning procedure.

In one advantageous embodiment, at least one of the closure components is able to be co-rotationally assembled on the drive shaft without tools, and/or releasable from the drive shaft without tools. Such an embodiment can easily be at least partially disassembled for a cleaning procedure.

In one advantageous embodiment, one of the closure components functions as an adjustment button, in particular as an adjustment nut, for setting the grinding coarseness. For this purpose, the closure component that functions as an adjustment button for setting the grinding coarseness can have a thread which is screwed onto a mating thread of the drive shaft. In particular, it can advantageously be provided that the relative spacing of a grinding rotor from a grinding stator is variable by rotating the adjustment button relative to the drive shaft.

As has already been mentioned, the coffee or spice mill can be designed as a manually driven mill. In particular, it can be advantageously provided that the housing is designed to be held in a hand of the user during a grinding procedure, whereby the user can activate the activation handle, for example a crank handle, with his/her other hand.

Alternatively, the coffee or spice mill can be designed as an electrically driven mill. In particular, it can advantageously be provided that the drive device has an electric drive motor.

### BRIEF DESCRIPTION OF THE DRAWING VIEWS

The subject matter of the disclosure is illustrated by way of example and schematically in the drawing, and will be described hereunder by means of the figures, wherein identical or functionally equivalent elements are in most instances provided with the same reference signs also in different exemplary embodiments. In the figures:

FIG. 1 shows a cross-sectional illustration of a first exemplary embodiment of a coffee or spice mill according to the disclosure, having a closure device in the open position;

FIG. 2 shows a detailed view of the closure device of the first exemplary embodiment in the open position;

FIG. 3 shows the first exemplary embodiment having the closure device in the closed position in a cross-sectional illustration;

FIG. 4 shows a detailed view of the closure device of the first exemplary embodiment in the closed position;

FIG. 5 shows a cross-sectional illustration of a second exemplary embodiment of a coffee or spice mill according to the disclosure, having a closure device in the open position;

FIG. 6 shows the second exemplary embodiment of a coffee or spice mill according to the disclosure, having the closure device in the closed position;

FIG. 7 shows a cross-sectional illustration of a third exemplary embodiment of a coffee or spice mill according to the disclosure, having a closure device in the closed position;

FIG. 8 shows a detailed view of the closure device in a cross-sectional illustration;

FIG. 9 shows a detailed view of the closure device of the third exemplary embodiment in the closed position;

FIG. 10 shows a detailed view of the closure device of the third exemplary embodiment in the open position;

FIG. 11 shows a lateral view of a fourth exemplary embodiment of a coffee or spice mill according to the disclosure;

FIG. 12 shows a cross-sectional illustration of a fifth exemplary embodiment of a coffee or spice mill according to the disclosure, having a closure device in the open position; and

FIG. 13 shows the first exemplary embodiment having the closure device in the closed position in a cross-sectional illustration.

### DETAILED DESCRIPTION

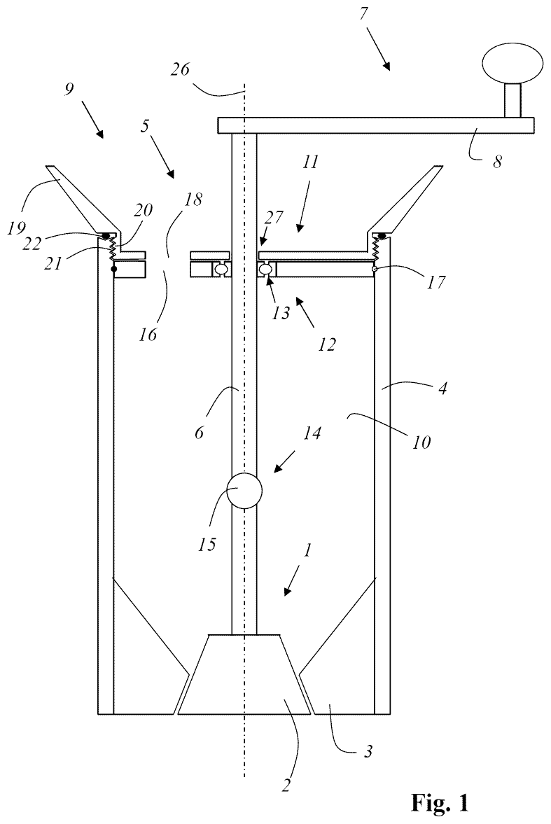

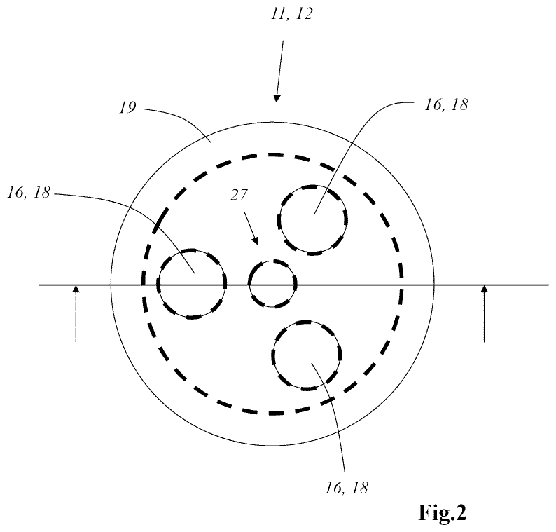

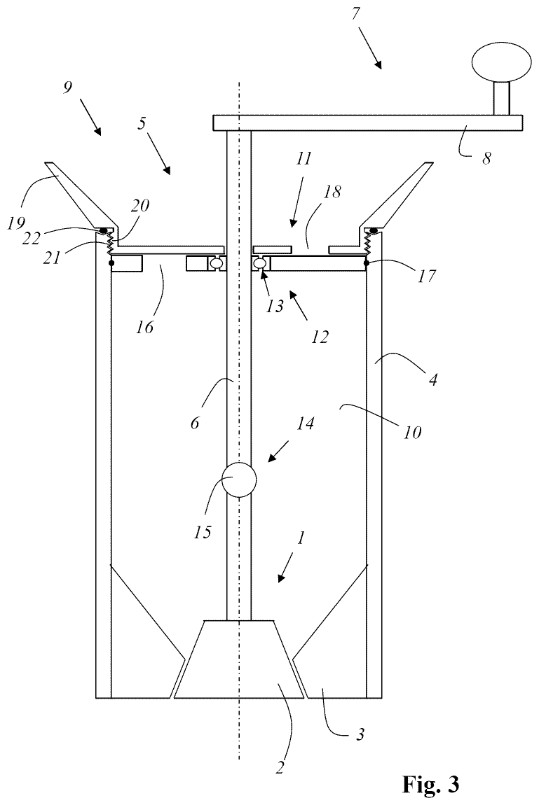

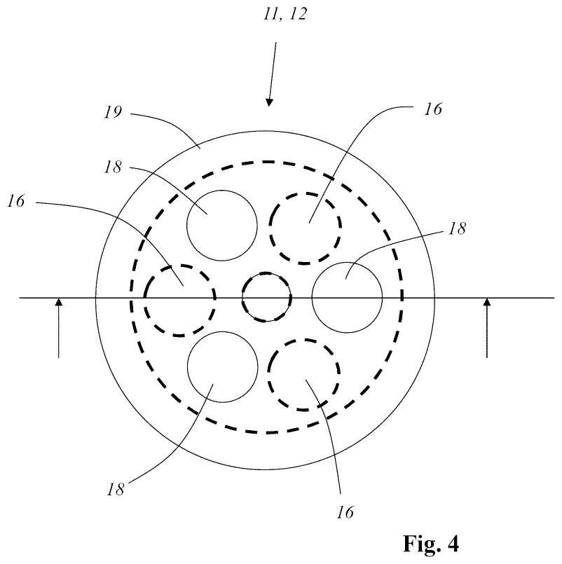

FIGS. 1 and 3 show in each case a cross-sectional illustration (corresponding to the section line plotted in FIGS. 2 and 4) of a first exemplary embodiment of a coffee or spice mill according to the disclosure, having a grinding gear 1 which has a grinding rotor 2, specifically a grinding cone, and a grinding stator 3, specifically a grinding ring. The coffee or spice mill moreover has a tubular housing 4 having an opening 5 and a drive shaft 6. The drive shaft 6 is co-rotationally connected to an activation handle 7, which is designed as a crank handle 8, on the one hand, and on the other hand co-rotationally connected to the grinding rotor 2 of the grinding gear 1.

Disposed in the region of the opening 5 is a closure device 9 by means of which a receptacle reservoir 10, which is disposed in the housing 4 and serves for receiving the (not illustrated) material to be ground (in the case of the design of the mill as a coffee mill: coffee beans; in the case of the design of the mill as a spice mill: spices such as pepper corns, for example), is able to be closed.

The closure device 9 has two closure components 11, 12. A first closure component 11 of the two closure components 11, 12 is mounted so as to be movable, specifically rotatable, relative to the housing 4. A second closure component 12 of the two closure components 11, 12 is disposed so as to be immovable relative to the housing 4. The closure components 11, 12 are able to be transferred relative to one another selectively to an open position (illustrated in FIGS. 1 and 2), in which material to be ground is able to be filled into the receptacle reservoir 10, or a closed position (illustrated in FIGS. 3 and 4), in which no material to be ground is able to be filled into the receptacle reservoir 10.

In addition to its function as a constituent part of the closure device 9, the second closure component 12 functions as a bearing bracket for rotationally mounting the drive shaft 6. For this purpose, the second closure component 12 has a rolling bearing 13. Additionally, there is an additional bearing bracket 14 which has a rod 15 (the direction of longitudinal extent of the rod 15 runs perpendicularly to the drawing plane), in the center of which is disposed an additional rolling bearing (not visible in the figures) for rotationally mounting the drive shaft 6.

The second closure component 12 has a circular disk-shaped portion in the center of which is formed a receptacle for the rolling bearing 13. Moreover, three passage openings 16 are formed in the circular disk-shaped portion. The three passage openings 16 are disposed so as to be spaced apart from the central axis 26 of the second closure component 12 in such a manner that a 120° rotational symmetry of the circular disk-shaped portion is formed. The second closure component 12 is fastened (for example in a friction-fitting manner) to the inside of the housing 4. For this purpose, the second closure component 12 on its outer circumferential periphery has a groove into which an O-ring 17 is placed. The O-ring 17 in turn engages in a groove formed on the inside of the housing 4.

The first closure component 11 likewise has a circular disk-shaped portion. A passage 27 for the drive shaft 6 is formed in the center in the circular disk-shaped portion of the first closure component 11. Moreover, three passage openings 18 are formed in the circular disk-shaped portion of the first closure component 11. The three passage openings 18 are disposed so as to be radially spaced apart from the central axis 26 of the first closure component 11 in such a manner that a 120° rotational symmetry of the circular disk-shaped portion is formed.

The first closure component 11 has a funnel-shaped portion 19 which functions as a funnel for filling material to be ground. The funnel-shaped portion 19 surrounds the circular disk-shaped portion and protrudes radially outwards beyond the housing 4, which facilitates the filling procedure. The funnel-shaped portion 19 (for example as an injection-molded part) can be formed integrally, conjointly with the circular disk-shaped portion that has the three passage openings 18.

The rotatable mounting of the first closure component 11 is implemented by means of a threaded connection (preferably fine thread). For this purpose, the first closure component 11 has a thread 20 which is designed as an external thread and into which a mating thread 21 is screwed, the latter being designed as an internal thread on the inside of the housing 4. A tensioning element in the form of an additional O-ring 22, which braces the thread 20 relative to the mating thread 21, is disposed between the annular end face of the housing 4 and the first closure component 11.

FIGS. 2 and 4 show in each case a top view from above onto the closure device 9, wherein the drive shaft 6 and the activation handle 7 are not plotted for reasons of improved clarity. The first closure component 11 is illustrated using solid lines, while the second closure component 12 is illustrated using dashed lines.

In the open position, which is illustrated in FIGS. 1 and 2, the three passage openings 16 of the first closure component 11 are co-aligned with the three passage openings 18 of the second closure component 12, so that material to be ground can be filled. Switching to the closed position can take place by rotating the first closure component 11 relative to the second closure component 12 by 60°. In the closed position, the passage openings 16 of the second closure component 12 are covered by the first closure component 11, and the passage openings 18 of the first closure component 11 are covered by the second closure component 12, so that no material to be ground can be filled, and material to be ground, which has already been filled, is accommodated in a protected manner in the receptacle reservoir 10.

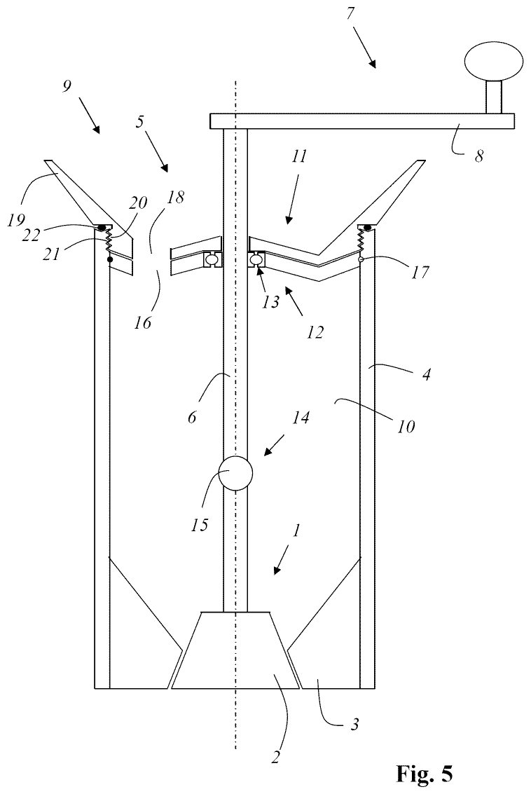

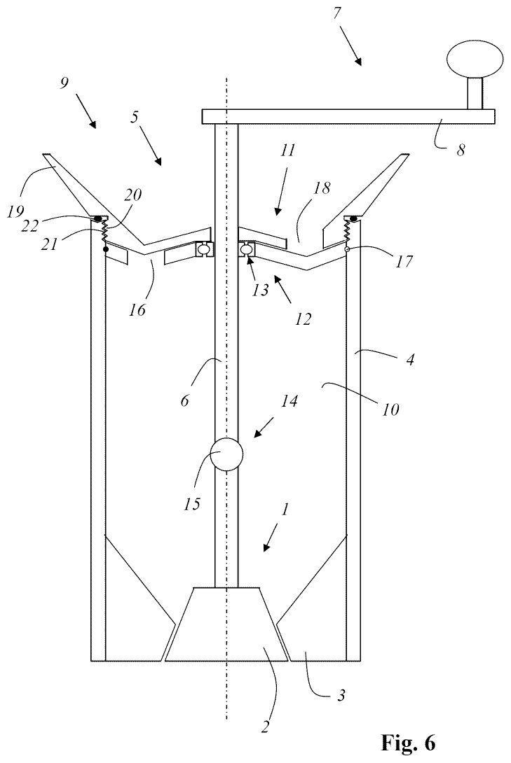

FIGS. 5 and 6 show in each case a cross-sectional illustration of a second exemplary embodiment of a coffee or spice mill according to the disclosure. The second exemplary embodiment differs from the first exemplary embodiment in that the first closure component 11 and the second closure component 12 do not have a respective disk-shaped portion in which the passage openings 16, 18 are formed, but have in each case a funnel-type portion which is designed as an annular funnel having an annular channel, wherein the passage openings 16, 18 are in each case formed on the base of the channel.

FIG. 5 shows a second exemplary embodiment having the closure device 9 in the open position, while FIG. 6 shows the second exemplary embodiment having the closure device 9 in the closed position.

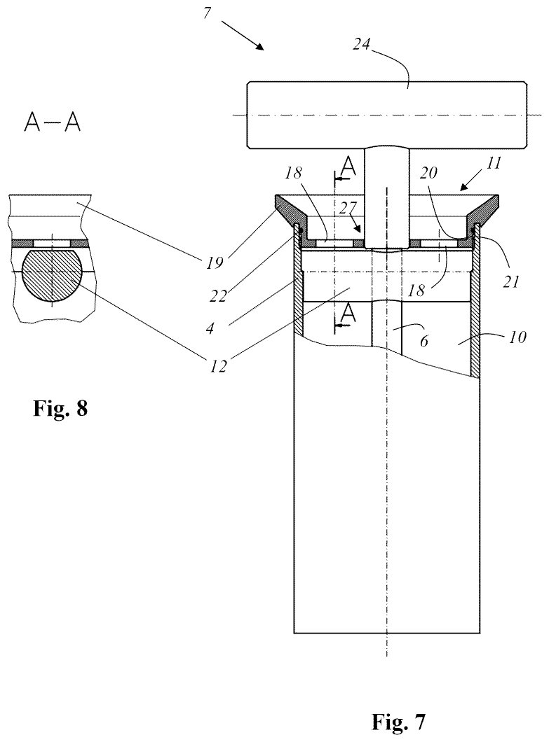

FIG. 7 shows a third exemplary embodiment of a coffee or spice mill according to the disclosure. In this embodiment, the second closure component 12 (disposed so as to be immovable relative to the housing 4) is designed in the shape of a rod. It can advantageously be provided here that the ends of the second closure component 12 are shaped so as to be complementary to those portions of the housing 4 on which said ends rest. The second closure component has a rod which in terms of its direction of longitudinal extent is disposed perpendicularly to the direction of longitudinal extent of the tubular housing 4, and is clamped in the interior of the housing. Also in this embodiment, the second closure component 12 functions as a bearing bracket for rotationally mounting the drive shaft 6. For this purpose, a rolling bearing (not visible in the figures) can be present in the center of the rod. As can be seen in FIG. 8, the rod has a circular segment-shaped cross section. This can be implemented in that, for example, a round rod of raw material is machined to be flat on its upper side. The flat area is aligned towards the first closure component 11.

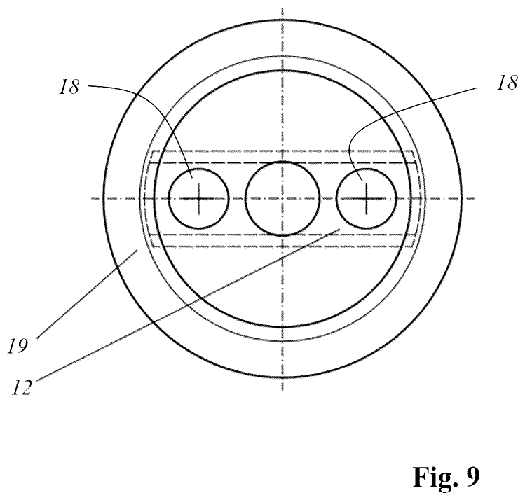

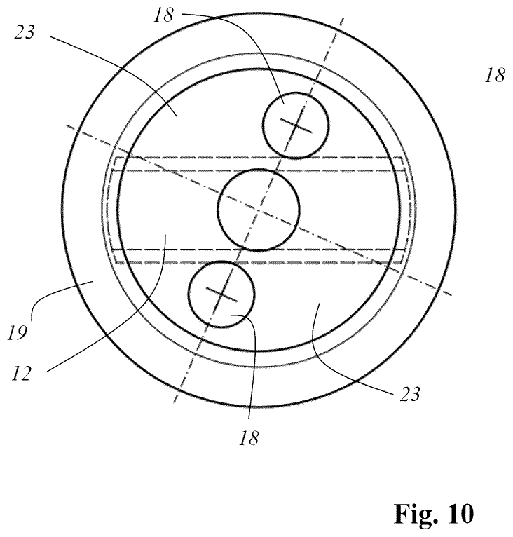

In this embodiment, the second closure component 12 has no passage openings 16 but is designed and disposed in such a way that it does not fill the entire area of the opening 5, so that a passage 23, which in the closed position (see FIG. 9) is covered and in the open position (see FIG. 10) is not covered by the first closure component 11, remains in each case on both sides between the second closure component 12 and the housing 4.

The first closure component 11 has a circular disk-shaped portion. A passage 27 for the drive shaft 6 is formed in the center in the circular disk-shaped portion of the first closure component 11. Moreover, two passage openings 18 are formed in the circular disk-shaped portion of the first closure component 11. The two passage openings 18 are disposed so as to be spaced apart from the central axis of the first closure component 11 in such a manner that a 180° rotational symmetry of the circular disk-shaped portion is formed.

The first closure component 11 has a funnel-shaped portion 19 which functions as a funnel for filling material to be ground. The funnel-shaped portion 19 surrounds the circular disk-shaped portion and protrudes radially outwards beyond the housing 4, which facilitates the filling procedure. The funnel-shaped portion (for example as an injection-molded part) can be formed integrally, conjointly with the circular disk-shaped portion that has the two passage openings 18.

The rotatable mounting of the first closure component 11 is implemented by means of a threaded connection (preferably fine thread). For this purpose, the first closure component 11 has a thread 20 which is designed as an external thread and into which a mating thread 21 is screwed, the latter being designed as an internal thread on the inside of the housing 4. A tensioning element in the form of an O-ring which braces the thread 20 relative to the mating thread 21 is in each case disposed between the thread 20 and the mating thread 21 so as to be in an encircling groove of the thread 20 and of the mating thread 21.

In the open position, which is illustrated in FIG. 10, the two passage openings 18 are co-aligned with the passages 23 so that material to be ground can be filled. Switching to the closed position can take place by sufficiently rotating the first closure component 11 relative to the second closure component 12. In the closed position, the passage openings 18 of the first closure component 11 are covered by the second closure component 12 (illustrated in FIGS. 7 and 9) in such a way that no material to be ground can be filled, and material to be ground which has already been filled is accommodated in a protected manner in the receptacle reservoir 10.

In the third exemplary embodiment, the activation handle 7 is designed as a rod handle 24 which in the center is co-rotationally connected to the drive shaft 6 (preferably releasably in a non-destructive manner and/or without tools).

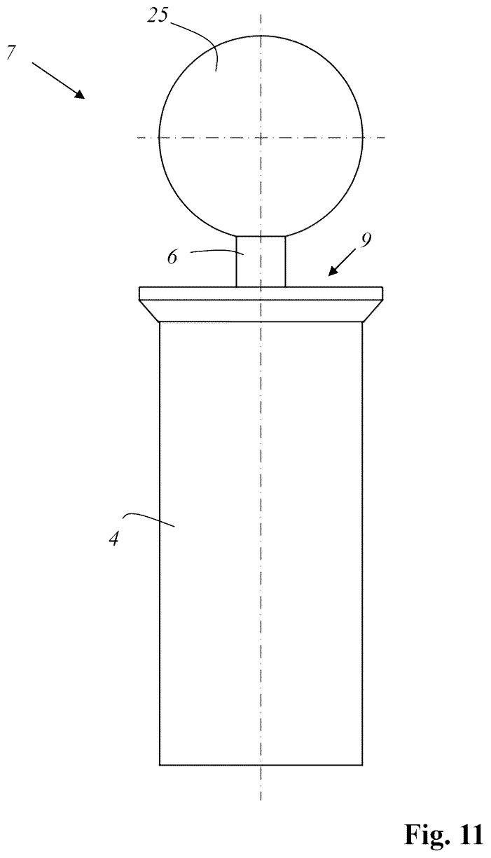

FIG. 11 shows a fourth exemplary embodiment which differs from the third exemplary embodiment on account of the embodiment of the activation handle 7. In the fourth exemplary embodiment, the activation handle 7 is designed as a ball 25.

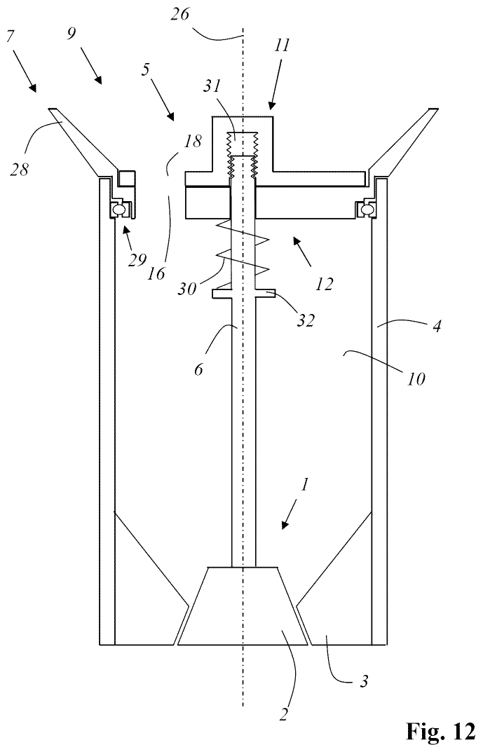

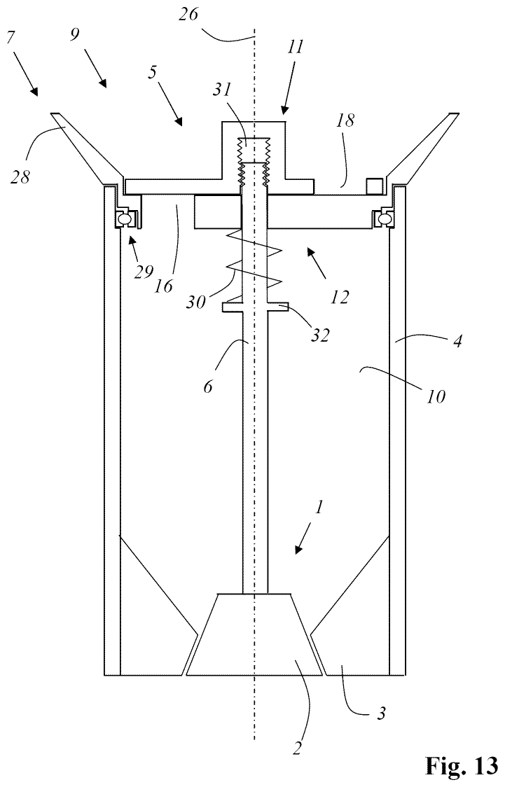

FIGS. 12 and 13 show in each case a cross-sectional illustration of a fifth exemplary embodiment of a coffee or spice mill according to the disclosure, having a closure device 9 and having a grinding gear 1 which has a grinding rotor 2, specifically a grinding cone, and a grinding stator 3, specifically a grinding ring. The coffee or spice mill moreover has a tubular housing 4 having an opening 5 and a drive shaft 6. The drive shaft 6 is co-rotationally connected (but so as to be temporarily releasable in a non-destructive manner for a cleaning procedure) to an activation handle 7 which is designed as a funnel 28 and as a constituent part of the closure device 9, on the one hand, and co-rotationally connected to the grinding rotor 2 of the grinding gear 1, on the other hand.

The closure device 9 is disposed in the region of the opening 5. A receptacle reservoir 10 which is disposed in the housing 4 and serves for receiving the (not illustrated) material to be ground (in the case of a design of the mill as a coffee mill: coffee beans; in the case of the design of the mill as a spice mill: spices such as peppercorns, for example), is able to be closed by means of the closure device.

The closure device 9 has two closure components 11, 12. The closure components 11, 12 are able to be transferred relative to one another selectively to an open position (illustrated in FIG. 12), in which material to be ground is able to be filled into the receptacle reservoir 10, or a closed position (illustrated in FIG. 13), in which no material to be ground is able to be filled into the receptacle reservoir 10.

The first closure component 11 has a circular disk-shaped portion. A threaded blind bore 13 for screwing the first closure component 11 onto a thread on the end of the drive shaft 6 is formed in the center in the circular disk-shaped portion of the first closure component 11. Moreover, three passage openings 18 are formed in the circular disk-shaped portion of the first closure component 11. The three passage openings 18 are disposed so as to be radially spaced apart from the central axis 26 of the first closure component 11 in such a manner that a 120° rotational symmetry of the circular disk-shaped portion is formed.

The first closure component 11 moreover functions as an adjustment

button for setting the grinding coarseness, because the relative spacing of the grinding rotor 2 from the grinding stator 3 is variable by rotating the first closure component 11 relative to the drive shaft. The relative spacing of the grinding rotor 2 from the grinding stator 3 is able to be reduced in that the first closure component 11 is screwed farther onto the drive shaft 6 (counter to the restoring force of a spring 30 which is supported on the second closure component 12, on the one hand, and on a shaft collar 32 of the drive shaft 6, on the other hand).

The second closure component 12 likewise has a first circular disk-shaped portion, a passage for co-rotationally coupling to the drive shaft 6 being formed in the center of the latter. For example, the drive shaft 6 and the passage can in each case have a cross section deviating from the circular shape, so as to implement a form-fitting co-rotational coupling. Alternatively or additionally, a co-rotational coupling can also be implemented by means of a radially extending stud bolt.

Moreover, three passage openings 16 are formed in the circular disk-shaped portion. The three passage openings 16 are disposed so as to be spaced apart from the central axis 26 of the second closure component 12 in such a manner that a 120° rotational symmetry of the circular disk-shaped portion is formed.

The second closure component 12 is rotatably mounted directly on the housing 4 by means of a rolling bearing 29. The drive shaft 6 to this extent is mounted indirectly, by way of the second closure component 12, so as to be rotatable relative to the housing 4. In this exemplary embodiment, the second closure component 12 is also an activation handle 7 which for operating the coffee or spice mill is rotated relative to the housing 4 by the user.

In the open position, the three passage openings 16 of the first closure component 11 are co-aligned with the three passage openings 18 of the second closure component 12 in such a way that material to be ground can be filled. Switching to the closed position can take place by rotating the first closure component 11 by 60° relative to the second closure component 12. In the closed position, the passage openings 16 of the second closure component 12 are covered by the first closure component 11, and the passage openings 18 of the first closure component 11 are covered by the second closure component 12, so that no material to be ground can be filled, and material to be ground which has already been filled can be accommodated in a protected manner in the receptacle reservoir 10. It is not relevant that the grinding coarseness is automatically also (slightly) varied when switching from the closed position to the open position because, upon filling, the first closure component 11 is rotated relative to the second closure component 12 back to the closed position, as a result of which the original grinding coarseness is automatically set.

### LIST OF REFERENCE SIGNS

1 Grinding gear
2 Grinding rotor
3 Grinding stator
4 Housing
5 Opening
6 Drive shaft
7 Activation handle
8 Crank handle
9 Closure device
10 Receptacle reservoir
11 First closure component
12 Second closure component
13 Rolling bearing
14 Additional bearing bracket
15 Rod
16 Passage opening
17 O-ring
18 Passage opening
19 Funnel-shaped portion
20 Thread
21 Mating thread
22 O-ring
23 Passage
24 Rod handle
25 Ball
26 Central axis
27 Passage
28 Funnel
29 Rolling bearing
30 Spring
31 Threaded blind bore
32 Shaft collar

What is claimed is:

1. A coffee or spice mill comprising:
a housing (4) having an opening (5);
a receptacle reservoir (10) disposed in the housing (4) for receiving material to be ground through the opening (5); and
a closure device (9) operable to close the receptacle reservoir (10);
wherein the closure device (9) has two closure components (11, 12) wherein at least one of the two closure components is movable relative to the housing (4), and wherein the two closure components (11, 12) are able to be transferred relative to one another selectively to an open position, in which material to be ground is able to be filled into the receptacle reservoir (10), and a closed position, in which no material to be ground is able to be filled into the receptacle reservoir (10).

2. The coffee or spice mill according to claim 1, wherein at least one of the two closure components (11, 12) has at least one passage opening (16, 18), which in the closed position of the two closure components (11, 12) is covered by the other one of the two closure components (11, 12) and in the open position of the two closure components (11, 12) is not covered by the other one of the two closure components (11, 12).

3. The coffee or spice mill according to claim 2, wherein the two closure components (11, 12) each have at least one passage opening (16, 18), wherein the at least one passage opening (16, 18) of one of the two closure components (11, 12) position is co-aligned with the at least one passage opening (16, 18) of the other of the two closure components (11, 12) when the two closure components (11, 12) are in the open position.

4. The coffee or spice mill according to claim 2, wherein at least one of the two closure components (11, 12) has a plurality of passage openings (16, 18) which in the closed position of the two closure components (11, 12) are covered by the other one of the two closure components (11, 12) and in the open position of the two closure components (11, 12) are not covered by the other one of the two closure components (11, 12).

5. The coffee or spice mill according to claim 4, wherein the two closure components (11, 12) each have a plurality of passage openings (16, 18), wherein the plurality of passage openings (16, 18) of one of the two closure components (11, 12) in the open position are co-aligned with the plurality of passage openings (16, 18) of the other of the two closure components (11, 12).

6. The coffee or spice mill according to claim 5, wherein the two closure components (11, 12) have the same number of passage openings (16, 18).

7. The coffee or spice mill according to claim 1, wherein one of the two closure components (11, 12) has no passage openings (16, 18) and does not fill an entire area of the opening (5), so that at least one passage, which in the closed position of the two closure components (11, 12) is covered by the other closure component (11, 12) and in the open position of the two closure components (11, 12) is not covered by the other closure component (11, 12), remains between the one of the two closure components (11, 12) and the housing (4).

8. The coffee or spice mill according to claim 2, wherein the at least one passage opening (16, 18) is formed in a circular disk-shaped or a funnel-type portion of the closure component (11, 12), and/or wherein the two closure components (11, 12) each have a circular disk-shaped or funnel-type portion, wherein at least one passage opening (16, 18) is formed in each of the circular disk-shaped or funnel-type portions.

9. The coffee or spice mill according to claim 8, wherein the at least one passage opening (16, 18) is spaced apart from a central axis (26) of the circular disk-shaped or funnel-type portion.

10. (canceled)

11. The coffee or spice mill according to claim 1, wherein one of the two closure components (11, 12) is rotatably mounted so as to be rotatable relative to the other of the two closure components (11, 12).

12. The coffee or spice mill according to claim 11, wherein the rotatable mounting is implemented by threaded connection.

13. The coffee or spice mill according to claim 11, wherein
a) the rotatably mounted closure component (11, 12) has a thread (20) which is screwed into a mating thread (21) that is stationary relative to the other closure component (11, 12) and/or the housing (4), or
b) the rotatably mounted closure component (11, 12) has a thread (20) which is screwed into a mating thread (21) that is formed on the housing (4).

14. (canceled)

15. The coffee or spice mill according to claim 14, further comprising a tensioning element which braces the thread (20) directly or indirectly relative to the mating thread (21).

16. The coffee or spice mill according to claim 15, wherein the tensioning element is a spring or a rubber ring.

17. The coffee or spice mill according to claim 1, further comprising a grinding gear (1) rotatable relative to the housing (4), wherein
a) at least one of the closure components (11, 12) functions as a bearing bracket for rotationally mounting a drive shaft (6) coupled to the grinding gear; and/or
b) a rotational mounting of one of the closure components (11, 12) functions as a rotational mounting of a drive shaft (6) coupled to the grinding gear.

18. The coffee or spice mill according to claim 17, wherein the rotational mounting has a rolling bearing (13).

19. The coffee or spice mill according to claim 17, further comprising at least one additional bearing bracket by which the drive shaft (6) is rotatably mounted.

20. The coffee or spice mill according to claim 17, wherein the drive shaft (6) extends through at least one of the closure components (11, 12), or the drive shaft (6) extends through both closure components (11, 12).

21. The coffee or spice mill according to claim 9, further comprising a grinding gear (1) rotatable relative to the housing (4) and a drive shaft (6) coupled to the grinding gear, wherein the drive shaft (6) is disposed coaxially with the central axis of the circular disk-shaped or funnel-type portion.

22. The coffee or spice mill according to claim 21, wherein one of the two closure components (11, 12) has a funnel-shaped portion to function as a funnel for filling material to be ground.

23. The coffee or spice mill according to claim 22, wherein the funnel-shaped portion protrudes radially outwards beyond the housing (4).

24. The coffee or spice mill according to claim 1, wherein a first of the two closure components (11, 12) is immovable relative to the housing (4).

25. The coffee or spice mill according to claim 24, wherein the coffee or spice mill has at least one of the following features a through i:
a) a second of the two closure components (11, 12) is movable relative to the housing (4);
b) the first closure component (11, 12) that is immovable relative to the housing (4) is fastened to the housing (4);
c) the first closure component (11, 12) that is immovable relative to the housing (4) is fastened in a friction-fitting manner to the housing (4);
d) the first closure component (11, 12), which is immovable relative to the housing (4), on its outer circumferential periphery has an elastic element which rests on an inside of the housing (4);
e) the first closure component (11, 12) that is immovable relative to the housing (4) has a circular disk-shaped or funnel-type portion having a groove which is formed on its outer circumferential periphery and into which is inserted an elastomer ring;
f) the first closure component (11, 12) that is immovable relative to the housing (4) is fastened to the housing (4) in a form-fitting manner;
g) the first closure component (11, 12) that is immovable relative to the housing (4) is fastened to the housing (4) in a materially integral manner;
h) the first closure component (11, 12) that is immovable relative to the housing (4) is fastened to the inside of the housing (4) without a materially integral connection;
i) the first closure component (11, 12) that is immovable relative to the housing (4) does not fill an entire area of the opening (5), so that at least one passage, which in the closed position is covered and in the open position is not covered by the second closure component (11, 12), remains between the first closure component (11, 12) and the housing (4).

26. The coffee or spice mill according to claim 21, wherein a first of the two closure components (11, 12) is disposed so as to be immovable relative to the drive shaft (6) which is coupled to the grinding gear.

27. The coffee or spice mill according to claim 26, characterized in that the coffee or spice mill has at least one of the following features a through e:
a) a second of two the closure components (11, 12) is movable relative to the housing (4);
b) the first closure component (11, 12) that is immovable relative to the drive shaft (6) is fastened to the drive shaft (6);
c) the first closure component (11, 12) that is immovable relative to the drive shaft (6) is fastened to the drive shaft (6) so as to be releasable from the drive shaft in a non-destructive manner and/or without tools;
d) the first closure component (11, 12) that is immovable relative to the drive shaft (6) is a funnel;
e) the first closure component (11, 12) that is disposed so as to be immovable relative to the drive shaft (6) is mounted by a rolling bearing so as to be rotatable relative to the housing (4).

28. The coffee or spice mill according to claim 1, wherein one of the two closure components (11, 12) is rod-shaped.

29. The coffee or spice mill according to claim 28, wherein the ends of the rod-shaped closure component (11, 12) are shaped so as to be complementary to corresponding respective portions of the housing (4) on which said ends rest.

30. (canceled)

31. The coffee or spice mill according to claim 1, wherein the coffee or spice mill further comprises an activation handle (7).

32. The coffee or spice mill according to claim 31, wherein the activation handle (7) is a crank handle or a rod handle or a ball or a funnel.

31. The coffee or spice mill according to claim 31, wherein the activation handle (7) is formed by one of the two closure components (11, 12).

34. (canceled)

35. (canceled)

36. (canceled)

37. (canceled)

38. (canceled)

39. (canceled)

40. (canceled)

41. (canceled)

42. (canceled)

43. The coffee or spice mill according to claim 1, wherein one of the two closure components (11, 12) functions as an adjustment nut for setting a grinding coarseness.

44. The coffee or spice mill according to claim 43, wherein the closure component (11, 12) that functions as an adjustment nut for setting the grinding coarseness has a thread (20) which is screwed onto a mating thread (20) of a drive shaft (6).

45. (canceled)

46. A coffee or spice mill comprising:
a grinding gear (1); and
an activation handle (7) connected to the grinding gear (1) for driving the grinding gear;
wherein the activation handle is configured as a funnel (28) for filling the coffee or spice mill with material to be ground.
